(19) United States
(12) Patent Application Publication
(10) Pub. No.: US 2009/0168244 A1
(43) Pub. Date: Jul. 2, 2009

(54) Magnetic recording medium, magnetic recording and reproducing apparatus, and method for manufacturing magnetic recording medium

(75) Inventors: Shuichi Okawa, Tokyo (JP); Kazuhiro Hattori, Tokyo (JP); Narutoshi Fukuzawa, Tokyo (JP); Takahiro Suwa, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/314,996

(22) Filed: Dec. 19, 2008

(30) Foreign Application Priority Data
Dec. 26, 2007 (JP) 2007-334410
Oct. 8, 2008 (JP) 2008-262167

(51) Int. Cl. G11B 5/82; B05D 5/12; B44C 1/22

(52) U.S. Cl. 360/135; 427/131; 216/22; G9B/5.293

(57) ABSTRACT

The magnetic recording medium includes: a substrate; a recording layer formed in a predetermined concavo-convex pattern over the substrate, the concavo-convex pattern including a convex portion that serves as a recording element; and a filling portion that fills a concave portion between the recording elements. The filling portion comprises a metal-based main filling material and nitrogen. Nitrogen is unevenly distributed in the filling portion such that the ratio of the number of nitrogen atoms to the total number of atoms of the main filling material and nitrogen atoms is greater in the upper surface portion of the filling portion than in the lower portion thereof.

### BACKGROUND OF THE INVENTION

1. Field of the Invention

The present invention relates to a magnetic recording medium having a recording layer formed in a concavo-convex pattern, to a magnetic recording and reproducing apparatus including the same, and to a method for manufacturing the magnetic recording medium.

2. Description of the Related Art

Conventional magnetic recording media such as hard disks have been significantly improved in areal density, for example, by employing finer magnetic grains or alternative materials for the recording layer and advanced micro-processing for magnetic heads. Although further improvements in areal density are still in demand, these conventional approaches to the improvement of areal density have already reached their limits due to several problems that have come to the surface. These problems include the limited accuracy of micro-processing of magnetic heads, erroneous recording of information onto those tracks adjacent to the target track due to spread of a recording magnetic field produced by the magnetic head, and crosstalk during reproducing operations.

In contrast to this, as candidate magnetic recording media that enable further improvements in areal density, those discrete track media or patterned media have been suggested, in which their recording layers are formed in a concavo-convex pattern and the convex portions of the concavo-convex pattern constitute recording elements (see, for example, Japanese Patent Application Laid-Open No. Hei 9-97419). On the other hand, for magnetic recording media such as hard disks, prime importance is placed on their surface flatness in order to stabilize the flying height of the head and thereby provide good recording/reproducing properties. Therefore, preferably, a filling material is deposited over a recording layer formed in a concavo-convex pattern to fill concave portions between recording elements, and the excess filling material over the recording layer is removed to flatten the top surfaces of the recording elements and the filling material. A non-magnetic nitride having a high hardness may be used as the filling material (see, for example, Japanese Patent Application Laid-Open No. 2006-139821). A sputtering method or the like may be used as the method for depositing the filling material to fill in the concave portions. Excessive filling material can be removed to flatten the surfaces, for example, by Chemical Mechanical Polishing (CMP) or dry etching.

However, when a nitride is used as the filling material, the magnetic properties of the recording layer can change as time goes by.

Moreover, the high hardness of nitride results in low etching rate, and therefore the production efficiency is low. Further, during deposition, a nitride target is bombarded with an inert gas to sputter nitride particles. Therefore, the deposition rate of nitride is low, and this also results in low production efficiency.

### SUMMARY OF THE INVENTION

In view of the foregoing problems, various exemplary embodiments of this invention provide a reliable magnetic recording medium including a recording layer that is formed in a concavo-convex pattern and does not significantly change magnetic properties of the recording layer, as well as a magnetic recording and reproducing apparatus including the above magnetic recording medium and a method for efficiently manufacturing the magnetic recording medium.

In various exemplary embodiments of the present invention, the above object is achieved by a magnetic recording medium including: a substrate; a recording layer formed in a predetermined concavo-convex pattern over the substrate, the concavo-convex pattern including a convex portion that serves as a recording element; and a filling portion that fills a concave portion between the recording elements. The filling portion comprises a metal-based main filling material and nitrogen. The nitrogen is unevenly distributed in the filling portion such that a ratio of the number of nitrogen atoms to the total number of atoms of the main filling material and the nitrogen atoms is greater in the upper surface portion of the filling portion than in the lower portion thereof.

In the course of completing the present invention, the present inventors have conducted extensive studies to determine the causes of the changes in magnetic properties of the recording layer over time when a nitride is used as the filling material. As a result of the studies, the inventors have presumed that the changes in magnetic properties of the recording elements are caused by the diffusion of nitrogen contained in the filling material to the recording element.

In the above magnetic recording medium, nitrogen is unevenly distributed in the filling portion such that the ratio of the number of nitrogen atoms is greater in the upper surface portion of the filling portion than in the lower portion of the filling portion. Therefore, a high hardness is obtained in the upper surface portion of the filling portion, and the diffusion of nitrogen from the lower portion of the filling portion to the recording element can be prevented or suppressed. Accordingly, changes in magnetic properties of the recording layer can be prevented or suppressed.

Moreover, in various exemplary embodiments of the present invention, the above object is achieved by a method for manufacturing a magnetic recording medium, including: producing a workpiece including a substrate and a recording layer formed in a predetermined concavo-convex pattern over the substrate, the concavo-convex pattern including a convex portion that serves as a recording element; depositing a metal-based main filling material on the workpiece to form a filling portion that fills a concave portion between the recording elements; and treating a surface of the workpiece with a nitrogen-containing processing gas to thereby introduce nitrogen into the filling portion.

Since the deposition rate of the metal-based material is higher than that of nitride, the main filling material can be efficiently deposited, and therefore the filling portion can be efficiently formed. Moreover, since the etching rate of the metal-based material is higher than that of nitride, the excess portions of the deposited main filling material can be efficiently removed. In addition, by treating the surface of the workpiece with the nitrogen-containing processing gas to thereby introduce nitrogen into the filling portion, a high hardness can be imparted to the upper surface portion of the filling portion. Therefore, the above magnetic recording medium can be efficiently manufactured.

Accordingly, various exemplary embodiments of this invention provide a magnetic recording medium, comprising: a substrate; a recording layer formed in a predetermined concavo-convex pattern over the substrate, the concavo-convex pattern including a convex portion that serves as a recording element; and a filling portion that fills a concave portion between the recording elements, wherein the filling portion comprises a metal-based main filling material and nitrogen, the nitrogen being unevenly distributed in the filling portion such that a ratio of the number of nitrogen atoms to the total number of atoms of the main filling material and the nitrogen atoms is greater in an upper surface portion of the filling portion than in a lower portion of the filling portion.

Moreover, various exemplary embodiments of this invention provide a method for manufacturing a magnetic recording medium, comprising: a workpiece producing step of producing a workpiece including a substrate and a recording layer, the recording layer being formed in a predetermined concavo-convex pattern over the substrate, the concavo-convex pattern including a convex portion that serves as a recording element; a main filling material deposition step of depositing a metal-based main filling material on the workpiece to thereby form a filling portion in a concave portion between the recording elements so as to fill the concave portion; and a nitrogen treatment step of treating a surface of the workpiece with a nitrogen-containing processing gas to thereby introduce nitrogen into the filling portion.

In the description of the present application, the phrase “a recording layer formed in a predetermined concavo-convex pattern including a convex portion that serves as a recording element” does not only refer to a recording layer in which a continuous recording layer is divided in a predetermined pattern so that the convex portions constituting the recording elements are completely separated from one another, but shall also cover the following: a recording layer in which the convex portions that are separated from one another in the data region are continuous in the vicinity of the boundary between the data region and the servo region; a recording layer, such as a helical or spiral one, which is formed continuously over part of the substrate; a recording layer which is separately formed on a top surface of a convex portion and a bottom surface of a concave portion of a concavo-convex pattern of an underlying layer, so that the portion formed on the top surface of the convex portion constitutes the recording element; a recording layer in which the concave portion is formed half way in the direction of thickness and continuous at the bottom portion; and a continuous-film recording layer which is deposited in a concavo-convex pattern following a concavo-convex pattern of an underlying layer.

In the description of the present application, the term “metal-based material” is used to refer to not only materials composed of metal elements but also materials composed of semimetal elements such as Si and Ge and composite materials of metal elements and semimetal elements. In the description of the present application, carbon is not a semimetal element.

In the description of the present application, the term “the upper surface portion of the filling portion” is used to refer to the surface of the filling portion that is on the side opposite to the substrate and to a portion in proximity to the surface.

In the description of the present application, the term “the lower portion of the filling portion” is used to refer to a portion of the filling portion that is located on the substrate side of the upper surface portion.

In the description of the present application, the phrase “the ratio of the number of nitrogen atoms to the total number of atoms of the main filling material and nitrogen atoms is greater in the upper surface portion of the filling portion than in the lower portion of the filling portion” is not limited to the case in which nitrogen is present over the entire filling portion, such as the case in which the lower portion of the filling portion contains a smaller amount of nitrogen than the upper surface portion or the case in which the ratio of the number of nitrogen atoms gradually decreases from the upper surface portion side of the filling portion to the substrate side. The phrase is also used to include the case in which nitrogen is present substantially only in the upper surface portion of the filling portion and is not substantially present in the lower portion of the filling portion.

In the description of the present application, the term “the upper surface of the recording element” is used to refer to the surface of the recording element that is on the side opposite to the substrate.

In the description of the present application, the term “temporary coating material containing carbon as a main component” is used to refer to a material in which the ratio of the number of C (carbon) atoms to the total number of atoms constituting the temporary coating material is 70% or more.

Moreover, in the description of the present application, the term “the magnetic recording medium” refers not only to hard disks, FLOPPY (Registered Trade Mark) disks, or magnetic tapes, which employ only magnetism for recording and reproducing information, but also to magneto-optical storage media such as MOs (Magneto Optical), which employ both magnetism and light, and heat-assisted storage media which employ both magnetism and heat.

### BRIEF DESCRIPTION OF THE DRAWINGS

FIG. 1 is a schematic perspective view illustrating a structure of a magnetic recording and reproducing apparatus according to a first exemplary embodiment of the present invention;

FIG. 2 is a schematic cross-sectional side view illustrating the structure of a magnetic recording medium of the magnetic recording and reproducing apparatus;

FIG. 3 is an enlarged cross-sectional side view illustrating the structure of a filling portion of the magnetic recording medium;

FIG. 4 is a flowchart showing the outline of manufacturing steps of the magnetic recording medium;

FIG. 5 is a schematic cross-sectional side view illustrating the structure of a starting body of a workpiece used in the manufacturing steps;

FIG. 6 is a schematic cross-sectional side view illustrating the shape of the workpiece having thereon a resin layer formed in a concavo-convex pattern;

FIG. 7 is a schematic cross-sectional side view illustrating the shape of the workpiece with a recording layer processed in a concavo-convex pattern;

FIG. 8 is a schematic cross-sectional side view illustrating the shape of the workpiece with a main filling material deposited over the recording layer;

FIG. 9 is a schematic cross-sectional side view illustrating the shape of the workpiece with the main filling material etched;

FIG. 10 is a schematic cross-sectional side view illustrating the shape of the workpiece with the filling portions subjected to nitrogen treatment and with a first mask layer (temporary coating material) removed;

FIG. 11 is a schematic cross-sectional side view illustrating the structure of a magnetic recording medium according to a second exemplary embodiment of the present invention;

FIG. 12 is an enlarged cross-sectional side view illustrating the structure of a filling portion of the magnetic recording medium;

FIG. 13 is a schematic cross-sectional side view illustrating the structure of a starting body of a workpiece used in the manufacturing steps of the magnetic recording medium;

FIG. 14 is a schematic cross-sectional side view illustrating the shape of the workpiece having thereon a resin layer formed in a concavo-convex pattern;

FIG. 15 is a schematic cross-sectional side view illustrating the shape of the workpiece with a recording layer and a barrier film processed in a concavo-convex pattern;

FIG. 16 is a schematic cross-sectional side view illustrating the shape of the workpiece with a main filling material deposited over the recording layer and the barrier film;

FIG. 17 is a schematic cross-sectional side view illustrating the shape of the workpiece with the main filling material etched;

FIG. 18 is a schematic cross-sectional side view illustrating the shape of the workpiece with the filling portions subjected to nitrogen treatment and with a first mask layer (temporary coating material) removed;

FIG. 19 is a schematic cross-sectional side view illustrating the shape of a workpiece with a first mask layer over a recording element removed in a manufacturing step of a magnetic recording medium according to a third exemplary embodiment of the present invention; and

FIG. 20 is a graph showing element profiles, taken along thickness direction, of samples of Working Example 2 and Comparative Example 2.

### DETAILED DESCRIPTION OF THE PREFERRED EMBODIMENTS

Hereinafter, preferred exemplary embodiments of the present invention will be described in detail with reference to the drawings.

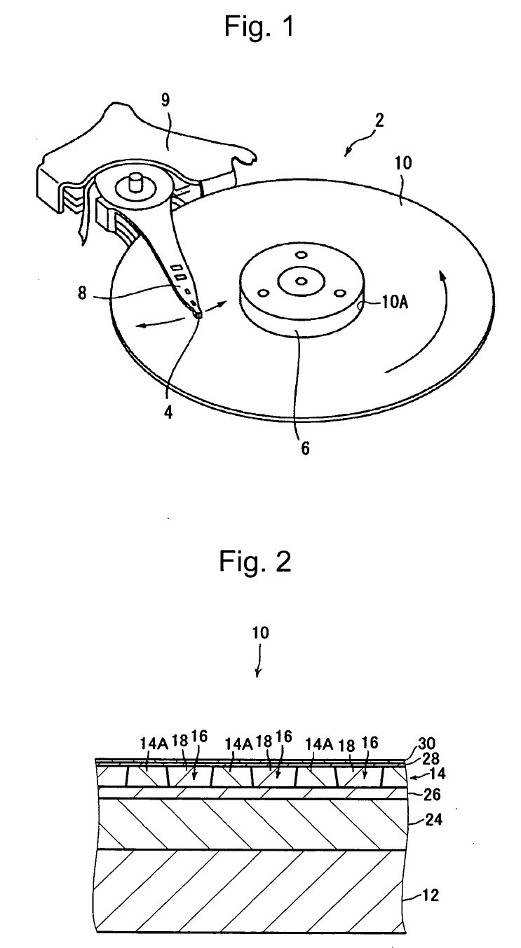

As shown in FIG. 1, a magnetic recording and reproducing apparatus 2 according to a first exemplary embodiment of the present invention includes a magnetic recording medium 10 and a magnetic head 4 that is disposed so as to be capable of flying in close proximity to the surface of the magnetic recording medium 10 for recording and reproducing magnetic signals on/from the magnetic recording medium 10.

The magnetic recording medium 10 has a center hole 10A and is secured to a chuck 6 through the center hole 10A. The magnetic recording medium 10 is rotatable together with the chuck 6. The magnetic head 4 is attached near the end of an arm 8, and the arm 8 is rotatably attached to a base 9. Therefore, the magnetic head 4 can move along an arc-shaped trajectory along the radial direction of the magnetic recording medium 10 while located in close proximity to the surface of the magnetic recording medium 10.

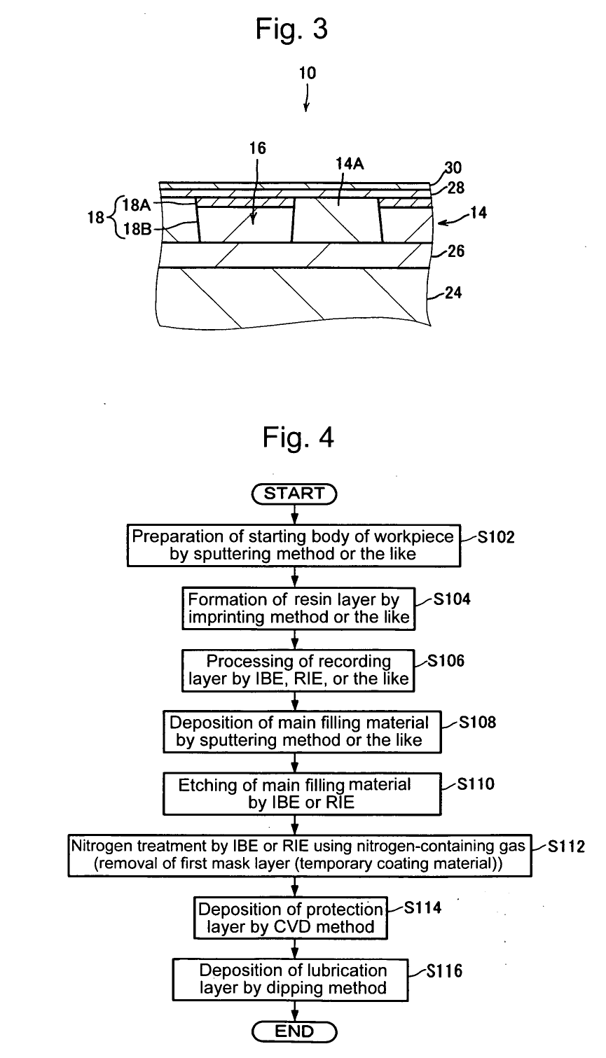

The magnetic recording medium 10 is a discrete track medium of a perpendicular recording type. As shown in FIGS. 2 and 3, the magnetic recording medium 10 includes: a substrate 12; a recording layer 14 formed in a predetermined concavo-convex pattern over the substrate 12, the concavo-convex pattern including convex portions that serve as recording elements 14A; and filling portions 18 that fill concave portions 16 between the recording elements 14A. The filling portion 18 substantially consists of a metal-based main filling material and nitrogen. The magnetic recording medium 10 is configured in such a manner that nitrogen is unevenly distributed in the filling portion 18 such that the ratio of the number of nitrogen atoms to the total number of atoms of the main filling material and nitrogen atoms is greater in an upper surface portion 18A of the filling portion 18 than in lower portion 18B of the filling portion 18. The description of the configuration of other components is omitted as appropriate because it does not seem to be important for an understanding of the first exemplary embodiment.

The magnetic recording medium 10 includes a soft magnetic layer 24, a seed layer 26, the recording layer 14, a protection layer 28, and a lubrication layer 30, and these layers are formed over the substrate 12 in that order.

The substrate 12 has a substantially disk-like shape with a center hole. Glass, Al, Al₂O₃, or the like may be used as the material for the substrate 12.

The recording layer 14 has a thickness of 5 to 30 nm. A CoPt-based alloy such as a CoCrPt alloy, an FePt-based alloy, a laminate thereof, a material composed of an oxide material forming a matrix, such as SiO₂, and ferromagnetic particles, such as CoCrPt particles, contained in the oxide material, or the like may be used as the material for the recording layer 14. In data regions, the recording elements 14A, which are convex portions of the recording layer 14, are formed in concentric arc shapes radially separated by fine intervals, as shown in FIGS. 2 and 3. In the data regions, the radial width of the upper surface of the recording elements 14A is 10 to 100 nm. Moreover, the radial width of the concave portion 16 at the level of the upper surface of the recording elements 14A is 10 to 100 nm. In servo regions, the recording elements 14A are formed in a predetermined servo pattern (not shown).

As described above, in the filling portion 18, nitrogen is unevenly distributed such that the ratio of nitrogen atoms to the total number of atoms of the main filling material and nitrogen atoms is greater in the upper surface portion 18A of the filling portion 18 than in the lower portion 18B. In other words, in the filling portion 18, the ratio of nitrogen atoms in the upper half of the filling portion 18 in the thickness direction (the side farther from the substrate 12) is greater than that in the lower half (the side closer to the substrate 12) in the thickness direction. Preferably, the main filling material constituting the filling portions 18 is a metal-based material containing at least one element selected from semimetal elements including Ge and Si and metal elements including Al, Ti, Ta, Nb, Zr, Ag, Au, Cu, Ir, Ru, Pt, Mn, Rh, Cr, Sb, and W. The main filling material may be an alloy of Al, Ti, Ta, Nb, Zr, Ag, Au, Cu, Ir, Ru, Pt, Mn, Rh, Cr, Sb, and/or W. Preferably, the upper surface portion 18A of the filling portion 18 is formed of a nitride of the main filling material. The filling portion 18 may contain molecules and atoms other than the main filling material or the nitride of the main filling material, so long as a sufficient hardness of the upper surface portion 18A is obtained. For example, the filling portion 18 may contain oxygen. It is preferable that the lower portion 18B of the filling portion 18 contains no nitrogen. However, the lower portion 18B of the filling portion 18 may contain nitrogen in a ratio less than that in the upper surface portion 18A. If the ratio of the number of nitrogen atoms is clearly different between the upper surface portion 18A and the lower portion 18B of the filling portion 18, the thickness of the upper surface portion 18A is preferably 1 to 5 nm. Preferably, the thickness of the upper surface portion 18A is equal to or less than one-fourth of the thickness of the recording layer 14. In the filling portion 18, the ratio of the number of nitrogen atoms may decrease substantially continuously from the upper surface portion 18A side to the substrate 12 side. Moreover, the lower portion 18B of the filling portion 18 may contain substantially no nitrogen. In this case, in the upper surface portion 18A of the filling portion 18, the ratio of the number of nitrogen atoms may decrease substantially continuously from the upper surface portion 18A side to the substrate 12 side. Furthermore, the lower portion 18B of the filling portion 18 may contain nitrogen in an amount significantly less than that contained in the upper surface portion 18A. In this case, in the upper surface portion 18A of the filling portion 18, the ratio of the number of nitrogen atoms may decrease substantially continuously from the upper surface portion 18A side to the substrate 12 side. When, in the upper surface portion 18A of the filling portion 18 or over the entire filling portion 18, the ratio of the number of nitrogen atoms decreases from the upper surface portion 18A side to the substrate 12 side, the ratio of the number of nitrogen atoms may decrease monotonically or may decrease in a fluctuating (increasing-decreasing) manner such that the midvalue of the fluctuations decreases in a macroscopic sense.

The soft magnetic layer 24 has a thickness of 50 to 300 nm. An Fe alloy, a Co alloy, or the like may be used as the material for the soft magnetic layer 24.

The seed layer 26 has a thickness of 2 to 40 nm. A nonmagnetic material such as a CoCr alloy, Ti, Ru, a laminate of Ru and Ta, MgO, or the like may be used as the material for the seed layer 26.

The protection layer 28 has a thickness of 1 to 5 nm. DLC (diamond-like carbon) may be used as the material for the protection layer 28.

The lubrication layer 30 has a thickness of 1 to 2 nm. PFPE (perfluoropolyether) may be used as the material for the lubrication layer 30.

A description will now be given of the action of the magnetic recording medium 10.

In the magnetic recording medium 10, nitrogen is unevenly distributed in the filling portion 18 such that the ratio of the number of nitrogen atoms is greater in the upper surface portion 18A of the filling portion 18 than in the lower portion 18B. Therefore, the upper surface portion 18A of the filling portion 18 has a high hardness, and the diffusion of nitrogen from the lower portion 18B of the filling portion 18 to the recording elements 14A can be prevented or suppressed. Accordingly, changes in magnetic properties of the recording layer 14 can be prevented or suppressed.

A description will now be given of a method for manufacturing the magnetic recording medium 10 with reference to the flowchart shown in FIG. 4.

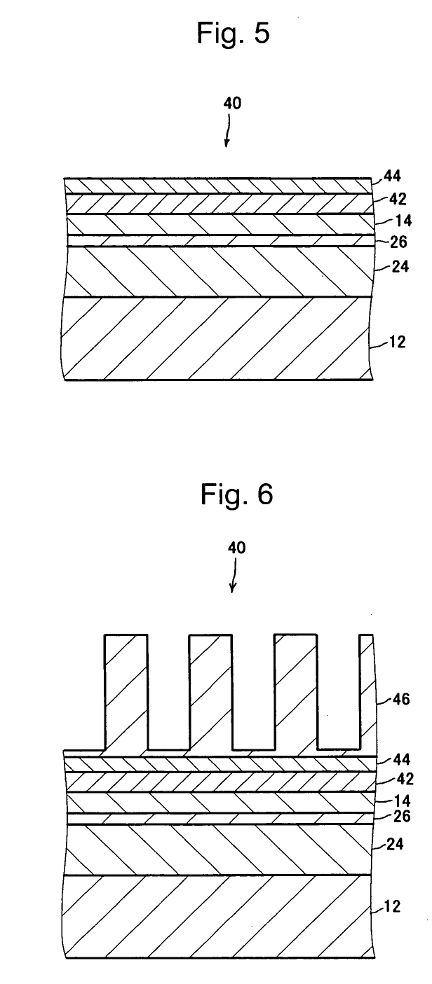

First, a starting body of a workpiece 40 shown in FIG. 5 is prepared (S102). The starting body of the workpiece 40 can be obtained by depositing the soft magnetic layer 24, the seed layer 26, the recording layer 14 (a continuous film before being processed into the concavo-convex pattern), a first mask layer 42, and a second mask layer 44 in that order over the substrate 12 using a sputtering method or the like.

The first mask layer 42 has a thickness of 3 to 50 nm. The first mask layer 42 serves also as a temporary covering material that is removed in a short time using a nitrogen-containing gas (such as N₂ gas or NH₃ gas) in a nitrogen treatment step (S112) described later. A material containing C (carbon) as a main component (such as DLC) may be used as the material for the first mask layer 42. The second mask layer 44 has a thickness of 3 to 30 nm. Ni or the like may be used as the material for the second mask layer 44.

Next, as shown in FIG. 6, a resin material is applied to the second mask layer 44 of the workpiece 40 using a spin coating method, and a concavo-convex pattern corresponding to the concavo-convex pattern of the recording layer 14 is transferred to the resin material by an imprinting method using a stamper (not shown), whereby a resin layer 46 having the concavo-convex pattern is formed (S104). Optical imprinting using UV rays or the like, thermal imprinting, or the like may be used as the imprint method. When optical imprinting is used, a UV curable resin or the like may be used as the material for the resin layer 46. When thermal imprinting is used, a thermoplastic resin or the like may be used as the material for the resin layer 46. The thickness of the resin layer 46 (the thickness of convex portion) is, for example, 10 to 300 nm. A photosensitive resist or an electron beam resist may be used as the resin material. In such a case, a resin layer 46 having a concavo-convex pattern corresponding to the concavo-convex pattern of the recording layer 14 may be formed by optical lithography or electron beam lithography. The resin layer 46 remaining at the bottom portions of the concave portions is removed by ashing or the like.

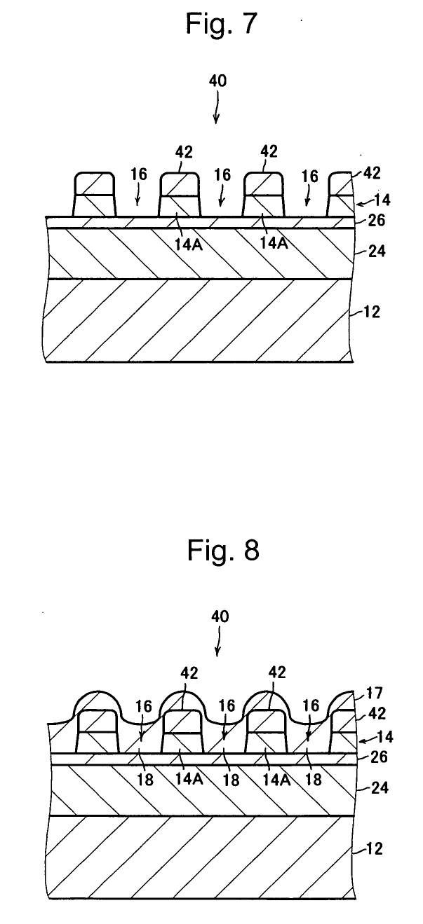

Next, the second mask layer 44 at the bottom portions of the concave portions is removed by IBE (Ion Beam Etching) using an inert gas such as Ar gas or RIE (Reactive Ion Etching), and the first mask layer 42 at the bottom portions of the concave portions is removed by IBE or RIE using O₂ gas. Then, the recording layer 14 at the bottom portions of the concave portions is removed by IBE using an inert gas such as Ar gas or RIE (S106). In this step, the recording layer 14 is formed into the concavo-convex pattern which is separated into a large number of recording elements 14A, as shown in FIG. 7. The first mask layer 42 remaining over the upper surfaces of the recording elements 14A is not removed and is used as a temporary coating material. In this manner, the workpiece 40 is obtained which includes: the substrate 12; the recording layer 14 formed in the predetermined concavo-convex pattern over the substrate 12, the concavo-convex pattern including the convex portions that serve as the recording elements 14A; and the first mask layer 42 (temporary coating material) formed over the recording elements 14A and containing carbon as a main component.

In the description of the present application, the term “IBE” is used as a generic term for a processing method, such as ion milling, in which a workpiece is irradiated with an ionized gas to remove a target material. Moreover, in the description of the present application, even when a gas, such as an inert gas, that is not chemically reactive with a target material is used, the term “RIE” is used when an RIE apparatus is used.

Next, as shown in FIG. 8, using a sputtering method or the like, a metal-based main filling material 17 is deposited on the workpiece 40 including the recording layer 14 formed in the concavo-convex pattern, whereby the filling portions 18 are formed in the concave portions 16 between the recording elements 14A (S108). The filling portions 18 are composed of the main filling material 17 and fill the concave portions 16. The main filling material 17 is deposited also on the first mask layer 42 (temporary covering material) over the recording elements 14A so as to cover the recording layer 14. Since the deposition rate of the metal-based material is higher than that of nitride, the main filling material 17 can be efficiently deposited, and therefore the filling portions 18 can be efficiently formed.

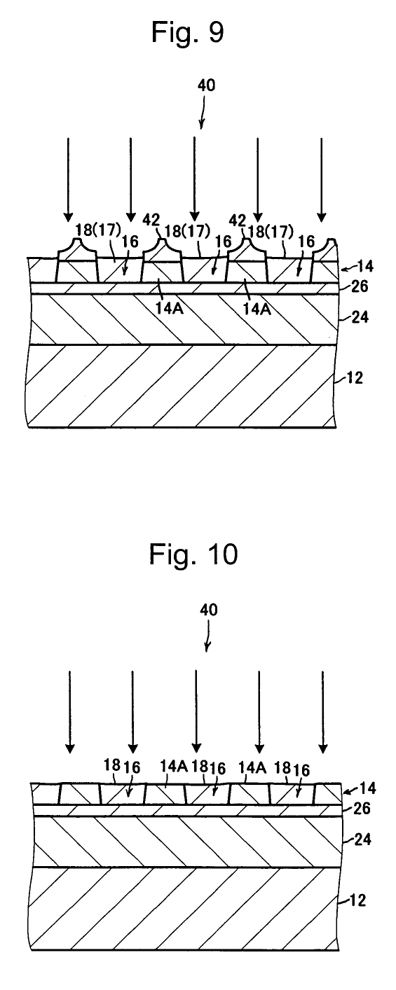

Next, as shown in FIG. 9, at least part of the excess portions of the main filling material 17 are removed by IBE using an inert gas such as Ar gas or RIE (S110). In the first exemplary embodiment, the term “the excess portions of the main filling material 17” is used to refer to portions of the main filling material 17 that are present on the upper side (the side opposite to the substrate 12) over the upper surface level of the recording layer 14. Since the etching rate of the metal-based material is higher than that of nitride, the excess portions of the deposited main filling material 17 can be efficiently removed. To increase the etching rate of the main filling material 17, it is preferable to use, as the main filling material 17, Ge, Si, Al, Ag, Au, Cu, Ir, Ru, Pt, Mn, Rh, Cr, or Sb or an alloy thereof.

In this step, the main filling material 17 is etched until at least part of the side surfaces of the first mask layer (temporary covering material) 42 are exposed from the main filling material 17. With a dry etching method, convex portions tend to be selectively removed at a faster rate than concave portions. In particular, IBE and RIE have a strong tendency to remove convex portions at a faster rate than concave portions. Therefore, the main filling material 17 that covers the first mask layer (temporary covering material) 42 can be efficiently removed. To increase the tendency to remove the convex portions of the main filling material 17 at a faster rate than the concave portions, it is preferable to use, as the main filling material 17, a material containing Al, Mn, Ti, V, or Si.

In this step, the irradiation angle of the processing gas is set to, for example, 90° relative to the surface of the workpiece 40. In the description of the present application, the term “the irradiation angle of the processing gas” is used to refer to the angle between the main traveling direction of the processing gas and the surface of the workpiece. For example, when the main traveling direction of the processing gas is parallel to the surface of the workpiece, the irradiation angle is 0°. When the main traveling direction of the processing gas is perpendicular to the surface of the workpiece, the irradiation angle is 90°. The arrows in FIG. 9 schematically indicate the traveling direction of the processing gas. When the irradiation angle of the processing gas is set to a large value as illustrated in the figure, a high etching rate is obtained, and this contributes to the improvement of the production efficiency. The processing gas travels less linearly in RIE than in IBE. Therefore, with RIE, even when the irradiation angle of the processing gas is set to 90° relative to the surface of the workpiece 40, part of the particles impinge on the workpiece 40 in a direction inclined relative to the surface of the workpiece 40. Therefore, the convex portions are easily etched at a faster rate than the concave portions, so that the first mask layer (temporary covering material) 42 on the recording elements 14A is easily exposed from the main filling material 17. The irradiation angle of the processing gas may be set to an angle smaller than 90°. In such a case, the tendency to remove the convex portions at a faster rate than the concave portions is increased. Therefore, the etching rate of the main filling material deposited on the side surfaces of the first mask layer (temporary covering material) 42 increases relative to that of other portions, so that the side surfaces of the first mask layer (temporary covering material) 42 are easily exposed.

When the main filling material 17 is a material that can be etched with a nitrogen-containing processing gas, such as N₂ gas or NH₃ gas, used in the next step (S112), the etching in this step is stopped at a point where the level of the upper surface of the main filling material 17 at the concave portions 16 is higher than the level of the upper surfaces of the recording elements 14A by the height of the main filling material 17 to be etched in the next step (S112), as shown in FIG. 9.

However, when the main filling material 17 is a material that is hardly etched with the nitrogen-containing processing gas, such as N₂ gas or NH₃ gas, used in the next step (S112), the etching in this step is stopped at a point where the level of the upper surface of the main filling material 17 at the concave portions 16 is substantially the same as the level of the upper surfaces of the recording elements 14A.

The first mask layer (temporary covering material) 42 remains on the recording elements 14A. Due to the presence of the first mask layer (temporary covering material) 42, the recording elements 14A are protected from being etched. After completion of this step, the main filling material 17 may remain on the first mask layer (temporary covering material) 42 over the recording elements 14A.

Next, as shown in FIG. 10, the surface of the workpiece 40 is treated with a nitrogen-containing processing gas. During this treatment, nitrogen is unevenly introduced into the filling portions 18 such that the ratio of the number of nitrogen atoms to the total number of atoms of the main filling material 17 and nitrogen atoms is greater in the upper surface portion 18A of the filling portion 18 than in the lower portion 18B. At the same time, the first mask layer (temporary covering material) 42 on the recording elements 14A is removed (S112). Specifically, the surface of the workpiece 40 is etched by IBE or RIE using the nitrogen-containing processing gas. Preferably, the nitrogen-containing processing gas is in the form of plasma. N₂ gas, NH₃ gas, or the like may be used as the nitrogen-containing processing gas.

Since the first mask layer (temporary covering material) 42 contains carbon as a main component, this layer chemically reacts with the nitrogen-containing processing gas, such as N₂ gas or NH₃ gas, so that the layer becomes brittle and is rapidly removed. The filling portions 18 that fill the concave portions 16 also chemically react with the nitrogen-containing processing gas. However, the filling portions 18, which are composed of a metal-based material, become less brittle as compared with carbon, and the introduction of nitrogen into the upper surface portions 18A increases the hardness of the upper surface portions 18A. Accordingly, the filling portions 18 are hardly removed. If the material for the filling portions 18 is, for example, Ge, the filling portions 18 can be partially removed. However, the etched amount of the filling portions 18 is less than that of the first mask layer (temporary covering material) 42. With the above procedure, the surface of the workpiece 40 is flattened. As described above, in the main filling material etching step (S110), the etching is stopped at a point where the level of the upper surface of the main filling material 17 at the concave portions 16 is higher than the level of the upper surfaces of the recording elements 14A by the height of the main filling material 17 to be etched in this step (S112). In this manner, flattening can be achieved with high precision. When the main filling material 17 remains on the first mask layer (temporary covering material) 42 over the recording elements 14A after completion of the main filling material etching step (110), the main filling material 17 is removed together with the first mask layer (temporary covering material) 42. The upper surfaces of the recording elements 14A are protected from the nitrogen-containing processing gas by the first mask layer 42 until the first mask layer (temporary covering material) 42 over the recording elements 14A is removed. Therefore, the upper surfaces of the recording elements 14A are exposed to the nitrogen-containing processing gas for a shorter time than the upper surface portions 18A of the filling portions 18. Accordingly, nitrogen can be introduced into the filling portions 18 while the diffusion of nitrogen into the upper surfaces of the recording elements 14A is suppressed.

Next, the protection layer 28 is formed over the recording elements 14A and the filling portions 18 by a CVD method (S114). Subsequently, the lubrication layer 30 is applied to the protection layer 28 by a dipping method (S116). In this manner, the magnetic recording medium 10 shown in FIGS. 2 and 3 is completed.

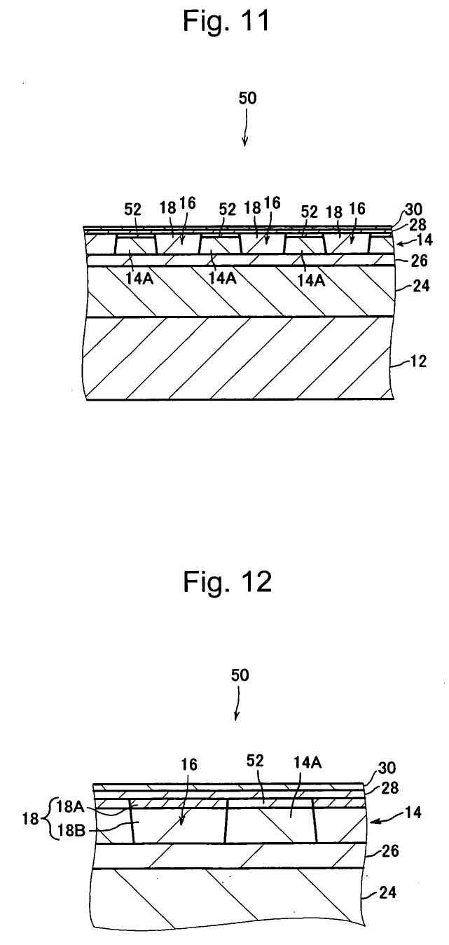

A description will now be given of a second exemplary embodiment of the present invention. In the magnetic recording medium 10 according to the first exemplary embodiment, the upper surfaces of the recording elements 14A are in contact with the protection layer 28. However, in a magnetic recording medium 50 according to the second exemplary embodiment, a barrier film 52 is formed between the upper surfaces of the recording elements 14A and the protection layer 28, as shown in FIGS. 11 and 12. Since the configuration of the other components is the same as that of the magnetic recording medium 10 according to the first exemplary embodiment, the same numerals as those used in FIGS. 1 to 10 are used for the same components, and the description thereof will be omitted.

The barrier film 52 has a thickness of 1 to 5 nm. SiO₂, MgO, ITO (Tin-Doped Indium Oxide), TaSi, TiN, TiO₂, SiC, or the like may be used as the material for the barrier film 52. In addition, Si, Ge, Mn, Ta, Nb, Mo, Zr, W, Al, Cu, Cr, Ti, Ag, Au, Ir, Ru, Pt, Rh, Sb, or the like, an alloy thereof, or a compound (except nitride) thereof may be used as the material for the barrier film 52.

As described above, the barrier film 52 is formed between the recording elements 14A and the protection layer 28, and the side surfaces of the barrier film 52 come in contact with the side surfaces of the upper surface portions 18A of the filling portions 18. Therefore, the side surfaces of the upper surface portion 18A of the filling portion 18 can be prevented from coming into contact with the side surfaces of the recording elements 14A, or the contact area therebetween can be reduced. Accordingly, the diffusion of nitrogen from the upper surface portion 18A of the filling portion 18 to the recording elements 14A can be prevented or reduced.

A description will now be given of a method for manufacturing the magnetic recording medium 50.

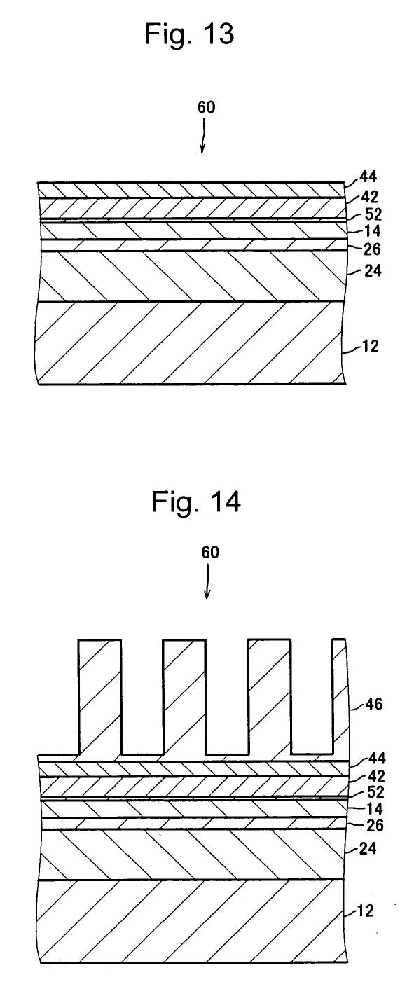

First, as shown in FIG. 13, a workpiece 60 is prepared which includes a barrier film 52 (a continuous film before being processed into a concavo-convex pattern) deposited between the recording layer 14 (a continuous film before being processed into a concavo-convex pattern) and the first mask layer 42 (S102). As in other layers, the barrier film 52 can be deposited by a sputtering method or the like.

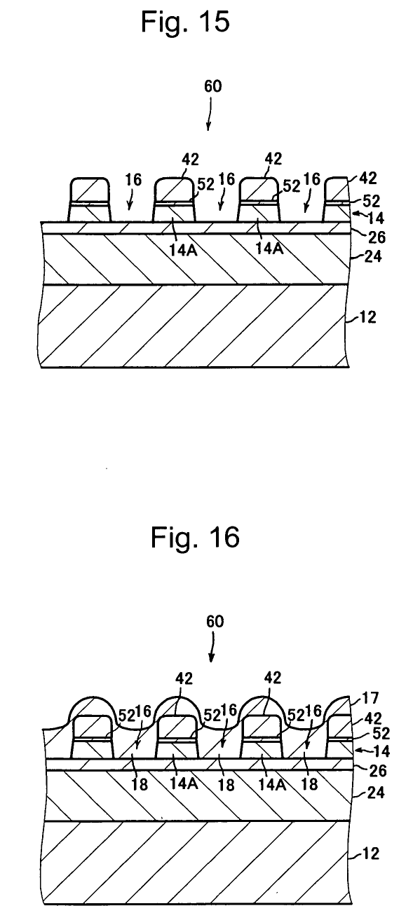

As in the first exemplary embodiment, the workpiece 60 is subjected to the resin layer forming step (S104), the recording layer processing step (S106), the main filling material deposition step (S108), the main filling material etching step (110), and the nitrogen treatment step (S112), as shown in FIGS. 14 to 18. Thereafter, the workpiece 60 is further subjected to the protection layer deposition step (114) and the lubrication layer deposition step (S116), whereby the magnetic recording medium 50 shown in FIGS. 11 and 12 is obtained.

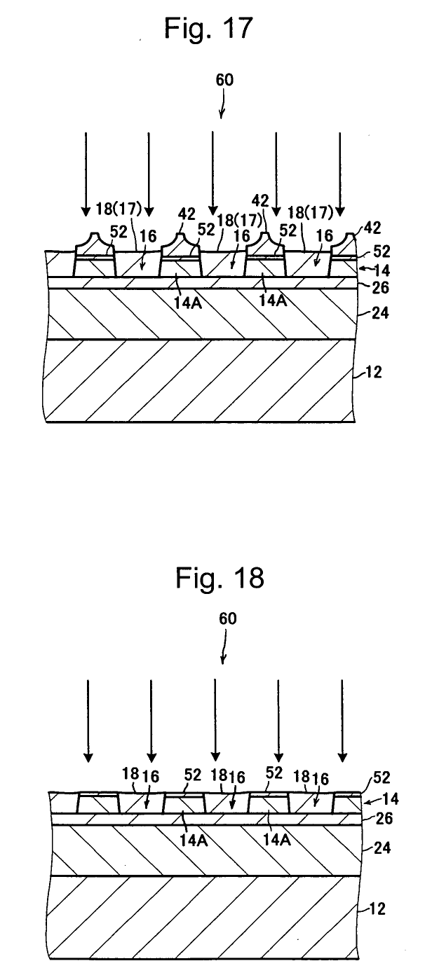

In the recording layer processing step (S106), the barrier film 52 at the bottoms of the concave portions is removed together with the recording layer 14 at the bottoms of the concave portions. In the main filling material etching step (110), at least part of the excess portions of the main filling material 17 that are present on the upper side (on the side opposite to the substrate 12) over the upper surface level of the barrier film 52 are removed. When the main filling material 17 is a material that can be etched with a nitrogen-containing processing gas, such as N₂ gas or NH₃ gas, used in the nitrogen treatment step (S112), the etching in this step is stopped at a point where the level of the upper surface of the main filling material 17 at the concave portions 16 is higher than the level of the upper surface of the barrier film 52 by the height of the main filling material 17 to be etched in the nitrogen treatment step (S112), as shown in FIG. 17. However, when the main filling material 17 is a material that is hardly etched with the nitrogen-containing processing gas, such as N₂ gas or NH₃ gas, used in the nitrogen treatment step (S112), the etching in this step is stopped at a point where the level of the upper surface of the main filling material 17 at the concave portions 16 is substantially the same as the level of the upper surface of the barrier film 52. In the nitrogen treatment step (S112), nitrogen is introduced into the filling portions 18 while the barrier film 52 remains on the recording elements 14A. In this manner, the upper surfaces of the recording elements 14A are protected from the nitrogen-containing gas, and the diffusion of nitrogen to the upper surfaces of the recording elements 14A can be reliably prevented.

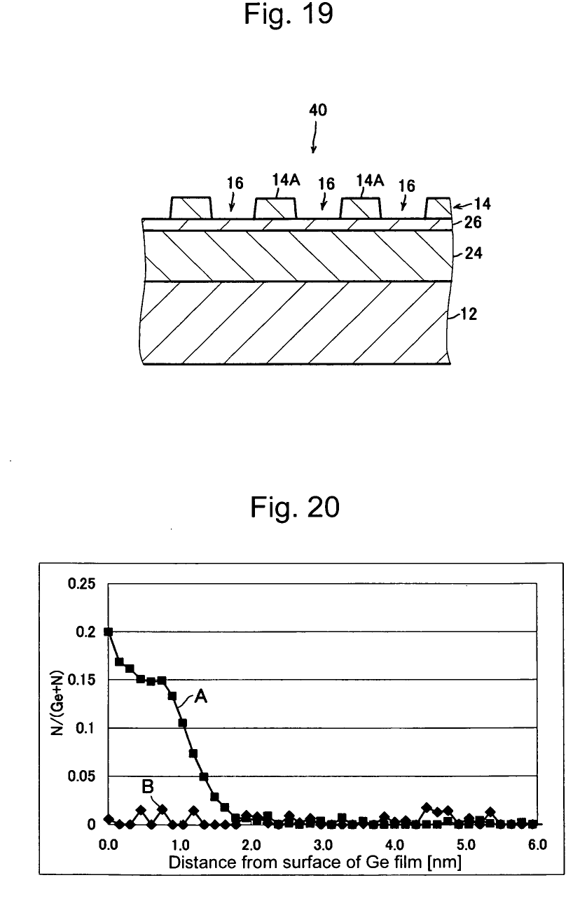

A description will now be given of a third exemplary embodiment of the present invention. In the first and second exemplary embodiments, nitrogen is introduced into the filling portions 18 in the nitrogen treatment step (S112). At the same time, the first mask layer 42 (temporary covering material) over the recording elements 14A is removed to thereby flatten the surface of the workpiece 40 (60). However, in the third exemplary embodiment, the temporary coating material is not used. More specifically, in the third exemplary embodiment, the first mask layer 42 remaining over the recording elements 14A is removed using O₂ gas or the like in the recording layer processing step (S106), as shown in FIG. 19. In the main filling material etching step (S110), the main filling material 17 over the recording elements 14A is removed to thereby flatten the surface of the workpiece 40 (60). More specifically, the workpiece 40 (60) is processed into the shape shown in FIG. 10 (FIG. 18) before the nitrogen treatment step (S112). In the nitrogen treatment step (S112), only the introduction of nitrogen into the filling portions 18 is performed. Since the configuration of the other components is the same as those in the first and second exemplary embodiments, the same numerals as those used in FIGS. 1 to 18 are used for the same components, and the description thereof will be omitted. For convenience, the step shown in FIG. 19 is for manufacturing the magnetic recording medium 10 of the first exemplary embodiment in which the barrier film 52 is not formed on the recording elements 14A. When the magnetic recording medium 50 of the second exemplary embodiment in which the barrier film 52 is formed on the recording elements 14A is to be manufactured, the first mask layer 42 remaining on the barrier film 52 over the recording elements 14A may be removed using O₂ gas or the like in the recording layer processing step (S106) (this process is not illustrated).

As described above, the first mask layer 42 remaining over the recording elements 14A may be removed in the recording layer processing step (S106), and only the introduction of nitrogen into the filling portions 18 may be performed in the nitrogen treatment step (S112). Also in such a case, a magnetic recording medium having a structure similar to those of the magnetic recording mediums 10 (50) of the first and second exemplary embodiments can be efficiently manufactured.

In the first to third exemplary embodiments, the filling portion 18 substantially consists of a metal-based main filling material and nitrogen. However, the filling portion 18 may contain oxygen in addition to a metal-based main filling material and nitrogen such that the ratio of nitrogen atoms to the total number of atoms of the main filling material and nitrogen atoms is greater in the upper surface portion 18A of the filling portion 18 than in the lower portion 18B, and the ratio of oxygen atoms to the total number of atoms of the main filling material and oxygen atoms is also greater in the upper surface portion 18A of the filling portion is 18 than in the lower portion 18B. The filling portion in which not only nitrogen but also oxygen is unevenly distributed can be formed by using processing gas containing oxygen-containing gas in addition to the nitrogen-containing gas in the nitrogen treatment step (S112).

In the first to third exemplary embodiments, the first mask layer 42, the second mask layer 44, and the resin layer 46 are formed over the continuous recording layer 14, and the recording layer 14 is divided into a concavo-convex pattern by three-step dry etching. However, no particular limitation is imposed on the material for the mask layers and the resin layer, the number of stacked layers, the thicknesses of these layers, the type of dry etching, and the like, so long as the recording layer 14 can be processed with high precision.

In the first to third exemplary embodiments, the soft magnetic layer 24 and the seed layer 26 are formed below the recording layer 14. However, the configuration of the layers below the recording layer 14 may be appropriately changed according to the type of the magnetic recording medium. For example, an underlayer and/or an antiferromagnetic layer may be formed between the soft magnetic layer 24 and the substrate 12. One or both of the soft magnetic layer 24 and the seed layer 26 may be omitted. Moreover, the recording layer may be formed directly on the substrate.

In the first to third exemplary embodiments, the magnetic recording medium 10 (50) is a discrete track medium of a perpendicular recording type in which the recording layer 14 is divided into tracks at fine intervals in the radial direction of the tracks. However, various exemplary embodiments of the present invention are, of course, applicable to: a patterned medium in which the recording layer is divided at fine intervals in both the radial and circumferential directions of the tracks; a magnetic disk having a spiral-shaped recording layer; a magnetic disk having a recording layer which is separately formed on upper surfaces of convex portions of a concavo-convex pattern of a layer lying below the recording layer and on concave portions of the concavo-convex pattern, wherein the portions formed on the upper surfaces of the convex portions serve as the recording elements; a magnetic disk having a recording layer having concave portions formed to a certain depth in the thickness direction, so that the recording layer is continuous in the bottom portion; and a magnetic disk having a continuous recording layer formed in a concavo-convex pattern following a concavo-convex pattern of a layer lying below the recording layer. Various exemplary embodiments of the present invention are applicable to a magnetic disk of a longitudinal recording type. Various exemplary embodiments of the present invention are applicable to a magnetic recording medium of a double-side recording type in which the recording layer and other layers are formed on both sides of the substrate. Moreover, the present invention is applicable to a magneto-optical disk such as MOs, a magnetic disk of a heat assisted type in which magnetism and heat are used in combination, and a magnetic recording medium, such as magnetic tape, having a shape other than a disk shape and including a recording layer formed in a concavo-convex pattern.

### WORKING EXAMPLE 1

The magnetic recording medium 10 was produced in the manner described in the first exemplary embodiment.

Specifically, in the starting body preparation step (S102) for the workpiece 40, the recording layer 14 was deposited to a thickness of 20 nm.

In the resin layer forming step (S104), a UV curable resin was used as the resin material, and the resin layer 46 was formed into a concavo-convex pattern corresponding to the concavo-convex pattern of the recording layer 14 by an optical imprinting method.

In the recording layer processing step (S106), the recording layer 14 was processed such that, in the date regions, the radial width of the upper surfaces of the recording elements 14A is 50 nm and the radial width of the concave portions 16 at the level of the upper surfaces of the recording elements 14A is 50 nm. The first mask layer (temporary covering material) 42 having a thickness of 20 nm remained on the recording elements 14A.

In the main filling material deposition step (S108), the main filling material 17 (being Ge) was deposited to a thickness of 50 nm by a sputtering method. The deposition rate of the main filling material 17 (Ge) was 0.3 nm/sec. The deposition conditions were as follows.

Source power (the power applied to the target): 500 W

Bias power (the power applied to the workpiece 50): 500 W

Inner pressure of the chamber: 0.3 Pa

Distance between the target and the workpiece: 300 mm

In the main filling material etching step (S110), the main filling material 17 at the concave portions 16 was removed by IBE using Ar gas to a level 10 nm above the upper surfaces of the recording elements 14A. The main filling material 17 over the recording elements 14A was completely removed. The etching rate of the main filling material 17 (Ge) was 1.2 nm/sec. The etching conditions were as follows.

Flow rate of Ar gas: 11 sccm

Inner pressure of the chamber: 0.03 Pa

Irradiation angle of the processing gas: 90°

Beam voltage: 1,000 V

Beam current: 500 mA

Suppressor voltage: −400 V

In the nitrogen treatment step (S112), the first mask layer 42 (temporary covering material) on the recording elements 14A was completely removed by RIE using N₂ gas. At this time, the main filling material 17 at the concave portions 16 was removed to the level of the upper surfaces of the recording elements 14A. The etching conditions were as follows.

Flow rate of N₂ gas: 50 sccm

Inner pressure of the chamber: 1.0 Pa

Microwave power: 1,000 W

RF power: 40 W

Processing time: 1 min

Subsequently, the protection layer deposition step (S114) and the lubrication layer deposition step (S116) were performed, whereby the magnetic recording medium 10 was produced.

The thus-obtained magnetic recording medium 10 was installed in the magnetic recording and reproducing apparatus 2, and the flying characteristics of the magnetic head 4 were tested. The flying characteristics were found to be stable.

Moreover, the recording and reproducing characteristics of the magnetic recording and reproducing apparatus 2 were tested. The recording and reproducing characteristics were found to be satisfactory.

Next, the magnetic recording medium 10 was removed from the magnetic recording and reproducing apparatus 2 and was held in a high temperature and high humidity environment (temperature: 85° C., relative humidity: 80%) for 48 hours. Subsequently, the magnetic recording medium 10 was again installed in the magnetic recording and reproducing apparatus 2, and the flying characteristics of the magnetic head 4 and the recording and reproducing characteristics of the magnetic recording and reproducing apparatus 2 were tested. The flying characteristics of the magnetic head 4 were found to be stable and similar to those before the magnetic recording medium 10 was held in the high temperature and high humidity environment. The recording and reproducing characteristics of the magnetic recording and reproducing apparatus 2 were also found to be satisfactory and similar to those before the magnetic recording medium 10 was held in the high temperature and high humidity environment.

### WORKING EXAMPLE 2

A glass substrate with a flat surface was prepared, and Ge was deposited on the glass substrate to a thickness of 50 nm by a sputtering method under the same conditions as those used in the main filling material deposition step (S108) in Working Example 1.

Next, the deposited Ge film was partially removed by IBE using Ar gas under the same conditions as those used in the main filling material etching step (110) in Working Example 1.

Subsequently, the surface of the deposited Ge film was subjected to nitrogen treatment by RIE using N₂ gas under the same conditions as those used in the nitrogen treatment step (S112) in Working Example 1.

Subsequently, a protection film of DLC was deposited to a thickness of 4 nm on the nitrogen treated surface of the Ge film.

The thus-obtained sample A was measured for its element profile in the thickness direction thereof (the relationship between the position in the thickness direction and the compositional ratio of the constituent elements in sample A) by etching the surface of the sample and detecting the amount of the sputtered elements by Auger electron spectroscopy. The measurement results are shown in FIG. 20. The curve labeled A represents the measurement results for sample A in Working Example 2.

### COMPARATIVE EXAMPLE 1

In contrast to Working Example 1 above, a filling material (being GeN) was deposited to a thickness of 50 nm in the main filling material deposition step (S108). The deposition conditions were the same as those in Working Example 1. The deposition rate of the filling material (GeN) was 0.05 nm/sec. The etching rate of the filling material (GeN) in a filling material etching step (corresponding to the main filling material etching step in Working Example 1) was 0.3 nm/sec. The etching conditions were the same as those in Working Example 1. However, the etching was stopped at a point where the filling material (GeN) over the concave portions 16 was etched to a height 2 nm above the upper surfaces of the recording elements 14A. Subsequently, in the nitrogen treatment step, the filling material (GeN) over the concave portions 16 was etched to a height corresponding to the level of the upper surfaces of the recording elements 14A such that the level of the upper surface of the filling material (GeN) coincided with the level of the upper surface of the recording element 14A upon completion of the nitrogen treatment step.

A magnetic recording medium was produced under the same conditions as those in Working Examples except for the above.

The thus-obtained magnetic recording medium was installed in the magnetic recording and reproducing apparatus, and the flying characteristics of the magnetic head were tested. The flying characteristics were found to be stable.

The recording and reproducing characteristics of the magnetic recording and reproducing apparatus were also tested. The recording and reproducing characteristics were found to be satisfactory.

As in Working Example 1, the magnetic recording medium was removed from the magnetic recording and reproducing apparatus and was held in a high temperature and high humidity environment (temperature: 85° C., relative humidity: 80%) for 48 hours. Subsequently, the magnetic recording medium was again installed in the magnetic recording and reproducing apparatus, and the flying characteristics of the magnetic head and the recording and reproducing characteristics of the magnetic recording and reproducing apparatus were tested. The flying characteristics of the magnetic head were found to be stable and similar to those before the magnetic recording medium was held in the high temperature and high humidity environment. However, the recording and reproducing characteristics of the magnetic recording and reproducing apparatus were changed from those before the magnetic recording medium was held in the high temperature and high humidity environment. Specifically, the S/N ratio of reproduced signals decreased by about 1 dB as compared to that before the magnetic recording medium was held in the high temperature and high humidity environment. Corrosion was not observed on the surface of the magnetic recording medium both before and after the magnetic recording medium was held in the high temperature and high humidity environment. The reduction in the S/N ratio of reproduced signals after the magnetic recording medium was held in the high temperature and high humidity environment, as compared to that before the magnetic recording medium was held in the high temperature and high humidity environment, may be due to the diffusion of nitrogen contained in the filling material (GeN) into the recording elements.

### COMPARATIVE EXAMPLE 2

In contrast to Working Example 2, the nitrogen treatment step (S112) was not performed. Sample B was produced under the same condition as those in Working Example 2 except for the above.

The thus-obtained sample B was measured for its element profile in the thickness direction thereof in the same manner as in Working Example 2. The measurement results are shown in FIG. 20. The curve labeled B represents the measurement results for sample B in Comparative Example 2.

As described above, in Working Example 1, after the main filling material containing no nitrogen was deposited to fill the concave portions, nitrogen was introduced into the upper surfaces of the filling portions filling the concave portions. In Comparative Example 1, the filling material containing nitrogen was deposited to form the filling portions. In both Working Example 1 and Comparative Example 1, the flying characteristics of the magnetic head were found to be satisfactory. In Working Example 1, the recording and reproducing characteristics were found to be better than those in Comparative Example 1.

The main filling material containing no nitrogen used in Working Example 1 exhibited significantly higher deposition rate and etching rate than the filling material (being a nitride) used in Comparative Example 1, and it was found that high production efficiency can be obtained in Working Example 1.

In Comparative Example 2, the nitrogen treatment step (S112) was not performed, and therefore the Ge film contained almost no nitrogen. However, in Working Example 2, the nitrogen treatment step (S112) was performed, and the Ge film was found to contain nitrogen in the upper surface portion within about 2 nm from the surface. In the upper surface portion of the Ge film in Working Example 2, the ratio of the number of nitrogen atoms was found to decrease substantially continuously toward the substrate side. Moreover, the lower portion of the Ge film in Working Example 2 was found to contain almost no nitrogen. Therefore, it was found that, by performing the nitrogen treatment step (S112), nitrogen can be unevenly distributed in the filling portions such that the ratio of nitrogen atoms to the total number of atoms of the main filling material and nitrogen atoms is greater in the upper surface portion of the filling portion than in the lower portion. In FIG. 20, the value of the curve labeled A is greater than zero at some points in the region 2 nm or more from the surface of the Ge film, and also the value of the curve labeled B is greater than zero at some points. This may be noise and may not indicate the presence of nitrogen.

Finally, a description will be given of an exemplary method for determining the compositional ratio of the constituent elements of the filling portion 18 of the magnetic recording medium 10.

First, the lubrication layer 30 of the magnetic recording medium 10 is peeled off, and the protection layer 28 is coated with carbon to a thickness of about 20 nm. Subsequently, a portion containing the recording elements 14A and the filling portions 18 is cut along a cutting plane parallel to the thickness and radial directions of the magnetic recording medium by an FIB (Focused Ion Beam) method such that the cut piece has a thickness of about 50 nm, whereby a TEM cross-sectional sample is produced. For example, FB2100 (product of Hitachi High-Technologies Corporation) can be used to produce the above sample.

TEM (Transmission Electron Microscope) observation and EDS (Energy-Dispersive X-ray Spectroscopy) analysis of the thus-obtained sample are performed at different points in the thickness direction (of the substrate 12), whereby a depth profile (a graph showing the relationship between the position in the thickness direction in the sample and the compositional ratio of the constituent elements) is obtained. For example, FE-TEM (JEM-2100F, product of JEOL Ltd.) or FE-STEM (HD2000, product of Hitachi High-Technologies Corporation) can be used for the measurement. Even when the compositional ratio of the number of nitrogen atoms is difficult to analyze, the compositional ratio of nitrogen can be computed by measuring the compositional ratios of components other than nitrogen.

What is claimed is:

1. A magnetic recording medium, comprising:
a substrate;
a recording layer formed in a predetermined concavo-convex pattern over the substrate, the concavo-convex pattern including a convex portion that serves as a recording element; and
a filling portion that fills a concave portion between the recording elements, wherein
the filling portion comprises a metal-based main filling material and nitrogen, the nitrogen being unevenly distributed in the filling portion such that a ratio of the number of nitrogen atoms to the total number of atoms of the main filling material and the nitrogen atoms is greater in an upper surface portion of the filling portion than in a lower portion of the filling portion.

2. The magnetic recording medium according to claim 1, wherein
the nitrogen contained in the filling portion is distributed substantially only in the upper surface portion, and the lower portion of the filling portion contains substantially no nitrogen.

3. The magnetic recording medium according to claim 1, wherein
the main filling material contains at least one element selected from the group consisting of Ge, Si, Al, Ti, Ta, Nb, Zr, Ag, Au, Cu, Ir, Ru, Pt, Mn, Rh, Cr, Sb, and W.

4. The magnetic recording medium according to claim 2, wherein
the main filling material contains at least one element selected from the group consisting of Ge, Si, Al, Ti, Ta, Nb, Zr, Ag, Au, Cu, Ir, Ru, Pt, Mn, Rh, Cr, Sb, and W.

5. A magnetic recording and reproducing apparatus, comprising:
the magnetic recording medium according to claim 1; and
a magnetic head for recording and reproducing a magnetic signal on/from the magnetic recording medium.

6. A magnetic recording and reproducing apparatus, comprising:
the magnetic recording medium according to claim 2; and
a magnetic head for recording and reproducing a magnetic signal on/from the magnetic recording medium.

7. A magnetic recording and reproducing apparatus, comprising:
the magnetic recording medium according to claim 3; and
a magnetic head for recording and reproducing a magnetic signal on/from the magnetic recording medium.

8. A method for manufacturing a magnetic recording medium, comprising:
a workpiece producing step of producing a workpiece including a substrate and a recording layer, the recording layer being formed in a predetermined concavo-convex pattern over the substrate, the concavo-convex pattern including a convex portion that serves as a recording element;
a main filling material deposition step of depositing a metal-based main filling material on the workpiece to thereby form a filling portion in a concave portion between the recording elements so as to fill the concave portion; and
a nitrogen treatment step of treating a surface of the workpiece with a nitrogen-containing processing gas to thereby introduce nitrogen into the filling portion.

9. The method according to claim 8, wherein
in the workpiece producing step the workpiece further including a temporary coating material formed over the recording element is produced, the temporary coating material contains carbon as a main component, and wherein in the nitrogen treatment step the nitrogen-containing processing gas is used to introduce nitrogen into the filling portion and to remove the temporary coating material.

10. The method for manufacturing a magnetic recording medium according to claim 9, wherein
in the workpiece producing step the recording layer formed into the predetermined concavo-convex pattern is formed by etching a continuous recording layer through use of a mask layer containing carbon as a main component, and wherein a portion of the mask layer that remains over the recording element is used as the temporary coating material.

11. The method for manufacturing a magnetic recording medium according to claim 9, wherein
further comprising, between the main filling material deposition step and the nitrogen treatment step, a main filling material etching step of etching the main filling material until at least part of a side surface of the temporary coating material is exposed from the main filling material.

12. The method for manufacturing a magnetic recording medium according to claim 10, wherein
further comprising, between the main filling material deposition step and the nitrogen treatment step, a main filling material etching step of etching the main filling material until at least part of a side surface of the temporary coating material is exposed from the main filling material.

13. The method for manufacturing a magnetic recording medium according to claim 8, wherein
in the workpiece producing step the workpiece further including a barrier film formed in contact with an upper surface of the recording element is produced, and wherein
in the nitrogen treatment step nitrogen is introduced into the filling portion while the barrier film remains on the recording element.

14. The method for manufacturing a magnetic recording medium according to claim 9, wherein
in the workpiece producing step the workpiece further including a barrier film formed in contact with an upper surface of the recording element is produced, and wherein
in the nitrogen treatment step nitrogen is introduced into the filling portion while the barrier film remains on the recording element.

15. The method for manufacturing a magnetic recording medium according to claim 10, wherein
in the workpiece producing step the workpiece further including a barrier film formed in contact with an upper surface of the recording element is produced, and wherein
in the nitrogen treatment step nitrogen is introduced into the filling portion while the barrier film remains on the recording element.

16. The method for manufacturing a magnetic recording medium according to claim 11, wherein
in the workpiece producing step the workpiece further including a barrier film formed in contact with an upper surface of the recording element is produced, and wherein
in the nitrogen treatment step nitrogen is introduced into the filling portion while the barrier film remains on the recording element.

17. The method for manufacturing a magnetic recording medium according to claim 8, wherein
the main filling material contains at least one element selected from the group consisting of Ge, Si, Al, Ti, Ta, Nb, Zr, Ag, Au, Cu, Ir, Ru, Pt, Mn, Rh, Cr, Sb, and W.

18. The method for manufacturing a magnetic recording medium according to claim 9, wherein
the main filling material contains at least one element selected from the group consisting of Ge, Si, Al, Ti, Ta, Nb, Zr, Ag, Au, Cu, Ir, Ru, Pt, Mn, Rh, Cr, Sb, and W.

19. The method for manufacturing a magnetic recording medium according to claim 10, wherein
the main filling material contains at least one element selected from the group consisting of Ge, Si, Al, Ti, Ta, Nb, Zr, Ag, Au, Cu, Ir, Ru, Pt, Mn, Rh, Cr, Sb, and W.

20. The method for manufacturing a magnetic recording medium according to claim 11, wherein
the main filling material contains at least one element selected from the group consisting of Ge, Si, Al, Ti, Ta, Nb, Zr, Ag, Au, Cu, Ir, Ru, Pt, Mn, Rh, Cr, Sb, and W.
